(19) United States
(12) Patent Application Publication
(10) Pub. No.: US 2013/0321663 A1
(43) Pub. Date: Dec. 5, 2013

(54) IMAGE PROCESSING DEVICE, IMAGE PROCESSING METHOD AND PROGRAM PRODUCT

(71) Applicant: KAGOSHIMA UNIVERSITY, Kagoshima (JP)

(72) Inventors: Sakuichi OHTSUKA, Kagoshima-shi (JP); Shoko Hira, Kagoshima-shi (JP); Ken Kihara, Kagoshima-shi (JP)

(21) Appl. No.: 13/904,767

(22) Filed: May 29, 2013

(30) Foreign Application Priority Data
May 31, 2012 (JP) 2012-124829

(51) Int. Cl. H04N 9/68

(52) U.S. Cl. CPC H04N 9/68
USPC 348/223.1

(57) ABSTRACT

There are provided: an original color image capturing unit capturing an original color image of a object represented by YCbCr; a Cr component elimination processing unit performing, on each pixel data of the original color image captured by the original color image capturing unit, processing to make a value of Cr component to be zero; a hue rotation processing unit performing, on each pixel data of the color image after being subjected to the processing performed by the Cr component elimination processing unit, hue rotation processing of 5 degrees to 50 degrees in a CbCr color space; and a display control unit performing a control to display the color image after being subjected to the hue rotation processing performed by the hue rotation processing unit, on a display section as a hue-converted color image.

### CROSS-REFERENCE TO RELATED APPLICATION

This application is based upon and claims the benefit of priority of the prior Japanese Patent Application No. 2012-124829, filed on May 31, 2012, the entire contents of which are incorporated herein by reference.

### BACKGROUND OF THE INVENTION

1. Field of the Invention

The present invention relates to an image processing device and an image processing method for performing processing of a color image, and a program product for causing a computer to execute the image processing method.

2. Description of the Related Art

Conventionally, there has been developed a technique in which a simulation is performed on a color vision of a so-called color deficient person to provide, to a normal color vision person, a visual perception of the color deficient person (refer to Non-Patent Document 1 described below, for example).

[Non-Patent Document 1] “Diversity of color vision and color vision barrier-free presentation”, Cell Technology, Shujunsha Co., Ltd., Internet <http://www.nig.ac.jp/color/barrierfree/barrierfree2-7.html>

However, in the conventional technique of color vision simulation, there is a problem that an operation amount related to image processing of a color image is large, and thus a processing load of the image processing in the color image is increased. For this reason, when a color image of moving image is subjected to image processing, for example, a situation in which the processing cannot be completed in a period of time within a frame rate, and it is not possible to deal with the moving image at real time, is caused, and further, an aid of dedicated hardware is required for solving the situation.

### SUMMARY OF THE INVENTION

The present invention is made in view of the problems as described above, and an object thereof is to provide a mechanism enabling a normal color vision person to grasp a visual perception of a color deficient person (Type-P(Protanopia)/Type-D(Deuteranopia) dichromat) while suppressing a processing load of image processing in a color image.

An image processing device of the present invention includes: a color image capturing unit capturing a color image of a object represented by a luminance signal, a first chromatic (color difference) signal of mainly yellow and blue, and a second chromatic (color difference) signal of mainly red and green; a second color difference signal elimination processing unit performing, on each pixel data of the color image, processing to make a value of the second color difference signal to be zero; a hue rotation processing unit performing, on each pixel data of the color image after being subjected to the processing performed by the second color difference signal elimination processing unit, hue rotation processing to eliminate a remaining red or green color component in a color space defined by the first color difference signal and the second color difference signal; and a display control unit performing a control to display the color image after being subjected to the hue rotation processing performed by the hue rotation processing unit, on a display section as a hue-converted color image.

Another aspect of the image processing device of the present invention includes: a color image capturing unit capturing a color image of a object represented by YCbCr; a Cr component elimination processing unit performing, on each pixel data of the color image, processing to make a value of Cr component to be zero; a hue rotation processing unit performing, on each pixel data of the color image after being subjected to the processing performed by the Cr component elimination processing unit, hue rotation processing of 5 degrees to 50 degrees in a CbCr color space; and a display control unit performing a control to display the color image after being subjected to the hue rotation processing performed by the hue rotation processing unit, on a display section as a hue-converted color image.

Further, the present invention includes an image processing method conducted by the above-described image processing device, and a program product for causing a computer to execute the image processing method.

### BRIEF DESCRIPTION OF THE DRAWINGS

FIG. 1 is a block diagram illustrating an example of hardware configuration of a multi-function mobile phone (image processing device) according to an embodiment of the present invention;

FIG. 2 is a block diagram illustrating an example of functional configuration of the multi-function mobile phone (image processing device) according to the embodiment of the present invention;

FIG. 3 illustrates the embodiment of the present invention, and is a schematic diagram illustrating an example of an original color image;

FIG. 4 illustrates the embodiment of the present invention, and is a schematic diagram illustrating an example of a CbCr color space; and

FIG. 5 is a flow chart illustrating an example of processing procedure of an image processing method performed by a multi-function mobile phone (image processing device) according to the embodiment of the present invention.

### DETAILED DESCRIPTION OF THE PREFERRED EMBODIMENTS

Hereinafter, modes (embodiments) to implement the present invention will be described with reference to the drawings. Note that in the embodiments of the present invention to be described hereinbelow, explanation will be made by citing an example in which a multi-function mobile phone (so-called smart phone) is applied as an image processing device according to the present invention, but, the present invention is not limited to this, and another image processing device such as, for example, a digital video camera and a PC (personal computer) can also be applied.

Further, the embodiments of the present invention to be explained hereinbelow describe a mechanism enabling a normal color vision person (trichromat) to grasp a visual perception of a Type-P/Type-D dichromat, who has difficulty in distinguishing reddish to greenish colors, and a percentage thereof is high, among color deficient people.

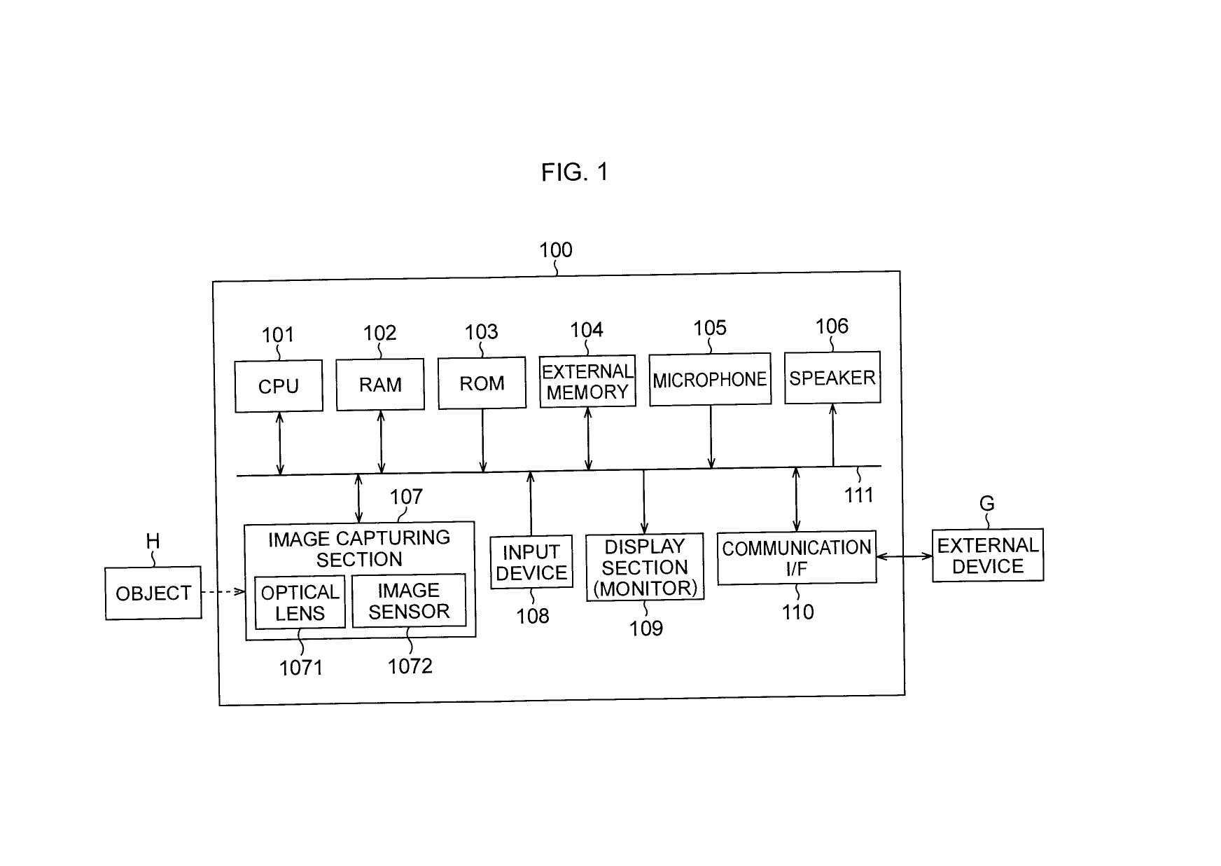

FIG. 1 is a block diagram illustrating an example of hardware configuration of a multi-function mobile phone (image processing device) 100 according to the embodiment of the present invention.

As illustrated in FIG. 1, the multi-function mobile phone 100 is configured to have a hardware configuration of a CPU 101, a RAM 102, a ROM 103, an external memory 104, a microphone 105, a speaker 106, an image capturing section 107, an input device 108, a display section 109, a communication interface (communication I/F) 110, and a bus 111.

The CPU 101 controls the entire multi-function mobile phone 100 by using a program, data or information stored in the ROM 103 or the external memory 104, for example.

The RAM 102 is formed of an SDRAM, a DRAM or the like, and has an area in which a program, data or information loaded from the ROM 103 or the external memory 104 is temporarily stored, and has a work area necessary for the CPU 101 to perform various types of processing.

The ROM 103 stores a program unnecessary to be changed, information such as various types of data and various types of parameters and the like.

The external memory 104 stores, for example, an operating system (OS) and a program executed by the CPU 101, and further, data and information regarded to be known in the explanation of the present embodiment. Note that in the present embodiment, a program for executing processing according to the embodiment of the present invention is set to be stored in the external memory 104, but, a mode in which the program is stored in the ROM 103, for example, is also applicable.

The microphone 105 and the speaker 106 are respectively used during telephone call when the multi-function mobile phone 100 is used as a telephone. Further, the microphone 105 is used for detecting a sound when the image capturing section 107 performs moving image photographing, and the speaker 106 is used for reproducing the sound detected by the microphone 105 when reproducing the moving image.

The image capturing section 107 captures an optical image of a object H as a color image represented by YCbCr. Here, YCbCr is a color space represented by using a luminance signal Y and two chromatic (color difference) signals Cb (B-Y) and Cr (R-Y). Hereinafter, the color image captured by the image capturing section 107 is referred to as “original color image”. The image capturing section 107 is configured to include an optical lens 1071 and an image sensor 1072. The optical lens 1071 is provided to lead the optical image from the object H to the image sensor 1072. The image sensor 1072 captures the optical image of the object H led via the optical lens 1071 as the original color image represented by YCbCr. Note that in the present embodiment, it is set that the image capturing section 107 captures an original color image of moving image.

The input device 108 is formed of, for example, a switch and a button equipped in the multi-function mobile phone 100, a transparent touch panel provided on the display section 109, and the like. The input device 108 is operated when a user gives various types of instructions to the multi-function mobile phone 100, for example, and inputs the instructions into the CPU 101 and the like.

The display section 109 is configured to include, for example, a monitor and the like, and outputs various types of images and various types of information to a monitor based on a control of the CPU 101.

The communication I/F 110 commands transmission/reception of various types of information, various types of signals and the like conducted between the multi-function mobile phone 100 and an external device G.

By the bus 111, the CPU 101, the RAM 102, the ROM 103, the external memory 104, the microphone 105, the speaker 106, the image capturing section 107, the input device 108, the display section 109, and the communication I/F 110 are connected in a mutually communicable manner.

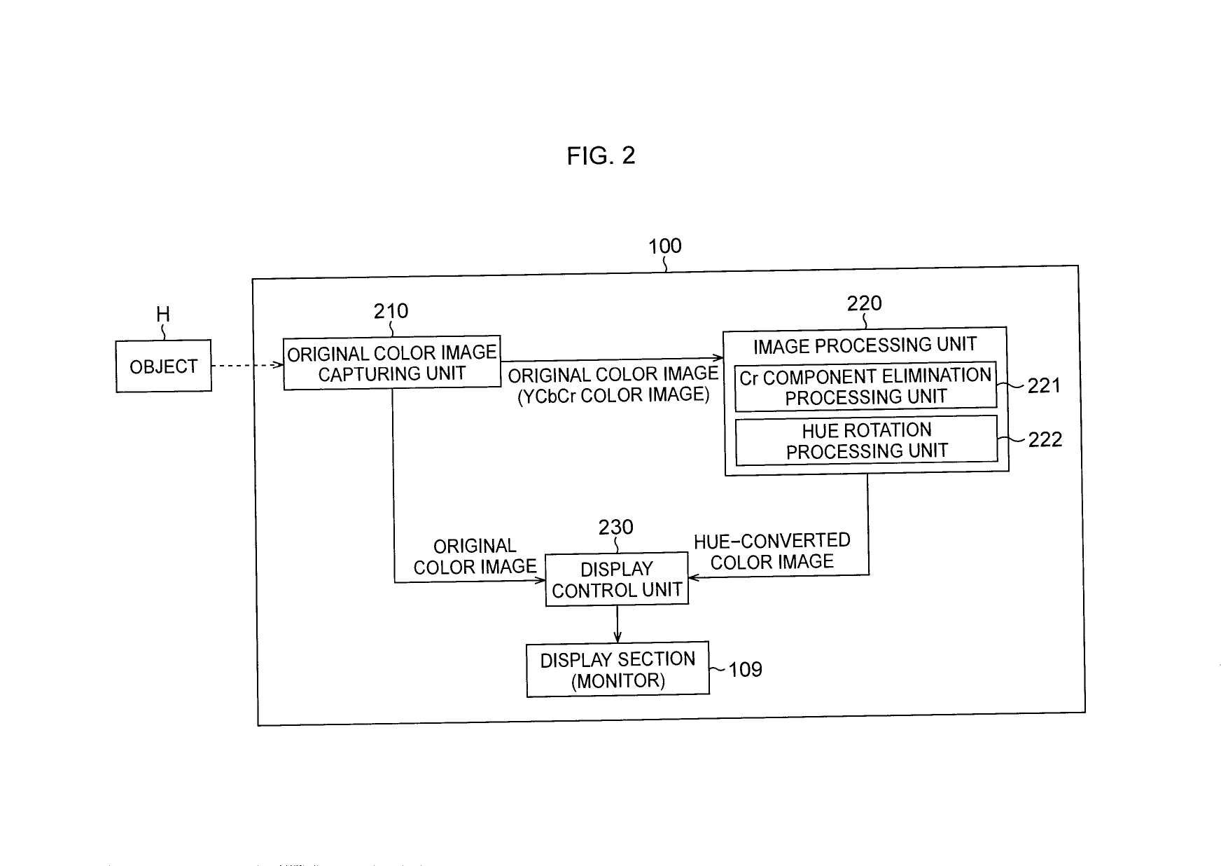

FIG. 2 is a block diagram illustrating an example of functional configuration of the multi-function mobile phone (image processing device) 100 according to the embodiment of the present invention. In FIG. 2, the same reference number is given to a configuration in terms of function same as the configuration illustrated in FIG. 1.

As illustrated in FIG. 2, the multi-function mobile phone 100 is configured to have a functional configuration of an original color image capturing unit 210, an image processing unit 220, a display control unit 230, and the display section 109.

Here, an example of a correspondence between the hardware configuration of the multi-function mobile phone 100 illustrated in FIG. 1 and the functional configuration of the multi-function mobile phone 100 illustrated in FIG. 2 will be described below.

For example, the original color image capturing unit 210 illustrated in FIG. 2 is configured by the image capturing section 107 illustrated in FIG. 1. Further, for example, the image processing unit 220 and the display control unit 230 illustrated in FIG. 2 are configured by the CPU 101, the program stored in the external memory 104, and the RAM 102 illustrated in FIG. 1. Note that in the above-described example, the original color image capturing unit 210 illustrated in FIG. 2 is set to be configured by the image capturing section 107 illustrated in FIG. 1, but, it is also possible to employ an example in which the original color image capturing unit 210 illustrated in FIG. 2 is configured by, for example, the CPU 101, the program stored in the external memory 104, and the RAM 102 illustrated in FIG. 1. In this case, an example in which the original color image capturing unit 210 illustrated in FIG. 2 captures the original color image captured by the image capturing section 107 illustrated in FIG. 1 from the image capturing section 107, is employed.

Subsequently, each functional configuration illustrated in FIG. 2 will be described.

The original color image capturing unit 210 captures an original color image of the object H represented by YCbCr, based on an optical image of the object H.

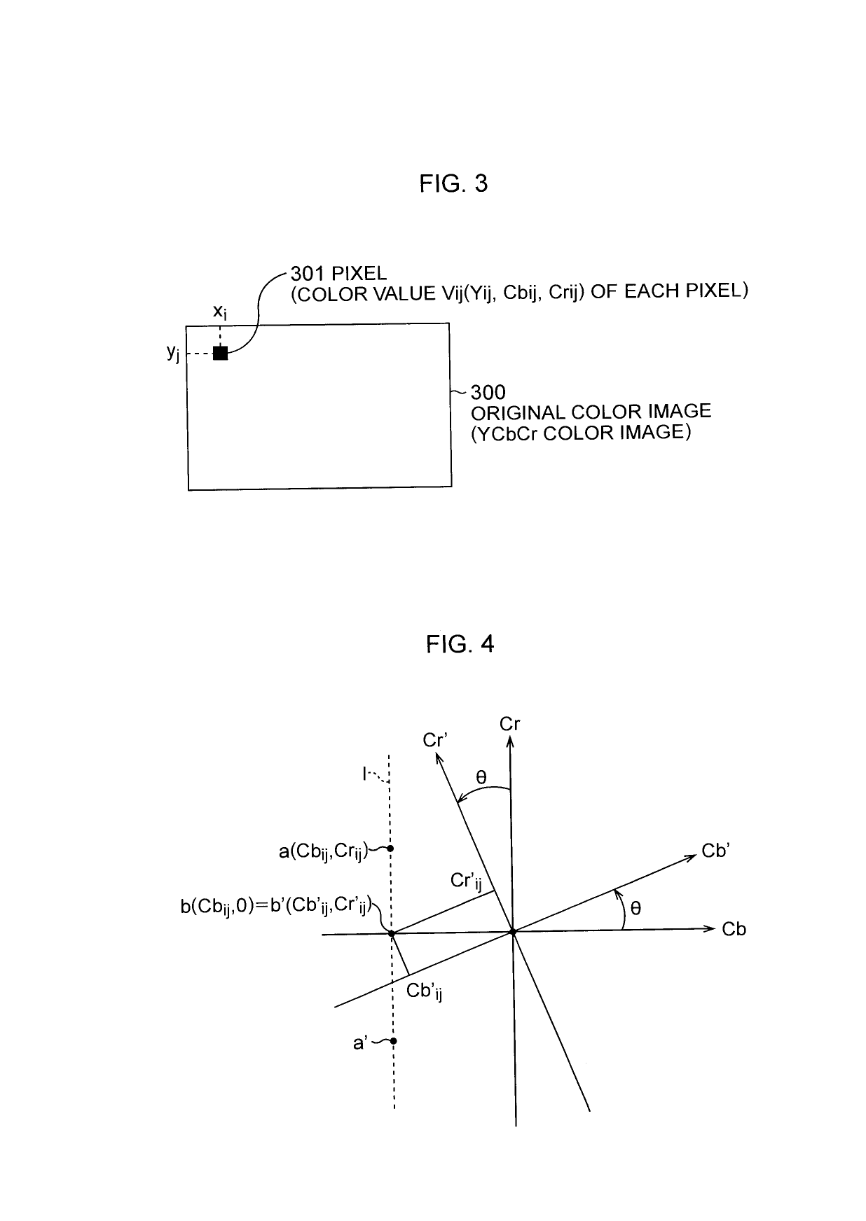

FIG. 3 illustrates the embodiment of the present invention, and is a schematic diagram illustrating an example of an original color image 300.

For example, the original color image capturing unit 210 captures the original color image 300 illustrated in FIG. 3. As illustrated in FIG. 3, this original color image 300 is configured to have a plurality of pixels 301 in a row direction (x direction) and a column direction (y direction). At this time, if i and j are set as arbitrary natural numbers, a color value Vᵢⱼ at a pixel (xᵢ, yⱼ) can be represented as (Yᵢⱼ, Cbᵢⱼ, Crᵢⱼ), as illustrated in FIG. 3.

The image processing unit 220 performs image processing (hue conversion processing) on the original color image captured by the original color image capturing unit 210, to thereby generate a hue-converted color image. Concretely, the image processing unit 220 is configured to include a Cr component elimination processing unit 221, and a hue rotation processing unit 222.

Here, the image processing unit 220 does not perform processing on the luminance signal _{Yip} out of the color value Vᵢⱼ (Yᵢⱼ, Cbᵢⱼ, Crᵢⱼ) at the pixel (xᵢ, yⱼ) of the original color image 300 illustrated in FIG. 3, so that processing in a CbCr color space being a two-dimensional chromatic (color difference) plane represented by CbCr can be considered.

FIG. 4 illustrates the embodiment of the present invention, and is a schematic diagram illustrating an example of the CbCr color space.

The CbCr color space in FIG. 4 is defined by a Cb axis provided in a horizontal direction and a Cr axis perpendicularly intersecting the Cb axis. Here, it is set that a point a (Cbᵢⱼ, Crᵢⱼ) in FIG. 4 is a pixel value before the image processing performed by the image processing unit 220.

The Cr component elimination processing unit 221 performs processing to make a value of Cr component to be zero, on each pixel data of the original color image captured by the original color image capturing unit 210. Through the processing of the Cr component elimination processing unit 221, the point a (Cbᵢⱼ, Crᵢⱼ) is moved to a point b (Cbᵢⱼ, 0) in FIG. 4. Generally speaking, through the processing of the Cr component elimination processing unit 221, all points a′ on a straight line 1 passing through the point a, and being parallel to the Cr axis, are degenerated into the point b in FIG. 4.

The hue rotation processing unit 222 performs hue rotation processing of 5 degrees to 50 degrees (about 15 degrees to 25 degrees, as an optimum value) in the CbCr color space, on each pixel data of the color image after being subjected to the processing performed by the Cr component elimination processing unit 221. Concretely, in the present embodiment, the hue rotation at an angle θ (θ=5 degrees to 50 degrees) is performed on CbCr (Cr=0) of pixel data, by using the following expression (1) and expression (2), namely, expressions for rotating the two-dimensional axes.

Cb′=Cb·cosθ+Cr·sinθ (1)

Cr′=−Cbcosθ+Cr·cosθ (2)

However, since Cr equals to 0 in the expression (1) and the expression (2), the actual calculation may be performed by using the following expression (3) and expression (4).

Cb′=Cb·cosθ (3)

Cr′=−Cb·sinθ (4)

In FIG. 4, the hue rotation processing corresponds to processing of representing the point b (Cbᵢⱼ, 0) defined by the Cb axis and the Cr axis as a point b′ (Cb′ᵢⱼ, Cr′ᵢⱼ) defined by a Cb′ axis and a Cr′ axis. Namely, in the present embodiment, the hue rotation processing is performed on each pixel data of the color image after being subjected to the processing performed by the Cr component elimination processing unit 221, by rotating and moving the Cb axis and the Cr axis defining the CbCr color space by the angle θ (θ=5 degrees to 50 degrees).

Through the image processing performed by the image processing unit 220 including the Cr component elimination processing unit 221 and the hue rotation processing unit 222, it is possible to generate a hue-converted color image as a result of removing, from the original color image, the color components of reddish to greenish colors, which are difficult to be distinguished by the Type-P/Type-D dichromat.

The display control unit 230 performs a control to display the hue-converted color image generated by the image processing unit 220 on the display section 109. At this time, the display control unit 230 performs a control, in accordance with an instruction from the user and the like, to make the hue-converted color image and the original color image before performing the image processing (hue conversion processing) to be displayed side-by-side on the display section 109, or to make both of the images to be alternately displayed on the display section 109.

Next, explanation will be made on a processing procedure of an image processing method performed by the multi-function mobile phone (image processing device) 100 according to the embodiment of the present invention.

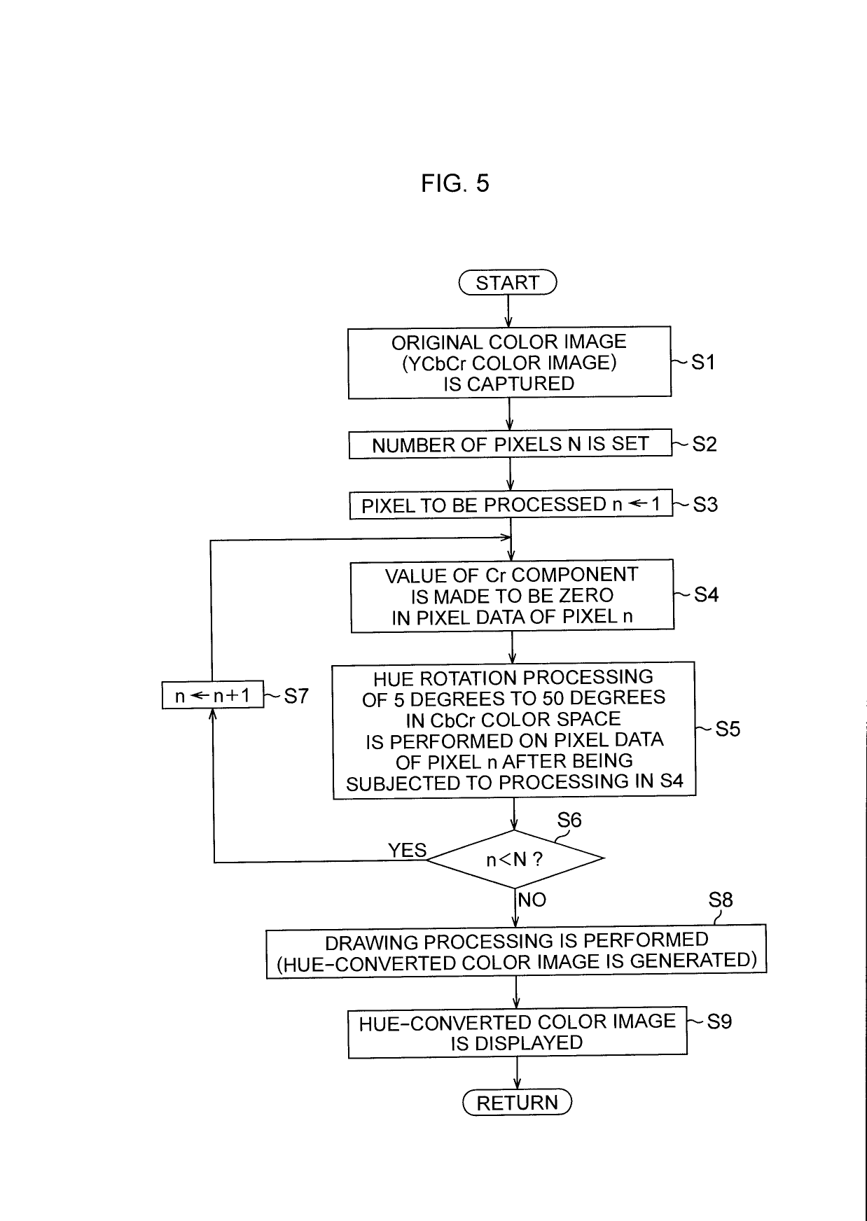

FIG. 5 is a flow chart illustrating an example of the processing procedure of the image processing method performed by the multi-function mobile phone (image processing device) 100 according to the embodiment of the present invention. The explanation of the flow chart illustrated in FIG. 5 is conducted by using the functional configuration of the multi-function mobile phone 100 illustrated in FIG. 2.

First, in step S1, the original color image capturing unit 210 captures the original color image of the object H represented by YCbCr, based on the optical image of the object H. Here, it is set that the original color image capturing unit 210 captures the original color image 300 illustrated in FIG. 3, for example.

Subsequently, in step S2, the image processing unit 220 captures the original color image captured in step S1, and then sets a number of pixels N of the original color image. Here, it is set that the image processing unit 220 sets a total number of pixels N of the original color image 300 illustrated in FIG. 3, and gives, to each of pixels forming the original color image 300, each number of 1 to N for specifying the each of the pixels, for example.

Subsequently, in step S3, the image processing unit 220 sets a variable n indicating a pixel to be processed, to 1. Accordingly, the pixel to be processed n, is set.

Subsequently, in step S4, the image processing unit 220 (or the Cr component elimination processing unit 221) first extracts pixel data of the pixel n in the original color image captured in step S1. Here, it is set that the image processing unit 220 (or the Cr component elimination processing unit 221) extracts the color value Vᵢⱼ (Yᵢⱼ, Cbᵢⱼ, Crᵢⱼ) being the pixel data of the pixel (xᵢ, y₃) in the original color image 300 illustrated in FIG. 3, for example. However, in the present embodiment, no processing is performed on the luminance signal Yᵢⱼ out of the color value Vᵢⱼ (Yᵢⱼ, Cbᵢⱼ, Crᵢⱼ) as described above, so that in the subsequent processing, the processing in the CbCr color space in FIG. 4 represented by CbCr is considered.

Next, the Cr component elimination processing unit 221 performs processing to make a value of Cr component to be zero, on the extracted pixel data of the pixel n. In this case, the Cr component elimination processing unit 221 performs processing to move, when the pixel data of the pixel n is the point a (Cbᵢⱼ, Crᵢⱼ) in FIG. 4, for example, the point a to the point b (Cbᵢⱼ, 0).

Subsequently, in step S5, the hue rotation processing unit 222 performs, on the pixel data of the pixel n after being subjected to the processing in step S4, the hue rotation processing of 5 degrees to 50 degrees in the CbCr color space. In this case, the hue rotation processing unit 222 is set to perform the hue rotation processing in which the point b (Cbᵢⱼ, 0) defined by the Cb axis and the Cr axis illustrated in FIG. 4 is set to the point b′ (Cb′ᵢⱼ, Cr′ᵢⱼ) defined by the Cb′ axis and the Cr′ axis, for example. Specifically, in the present embodiment, the hue rotation processing is performed on the pixel data of the pixel n after being subjected to the processing performed by the Cr component elimination processing unit 221, by rotating and moving the Cb axis and the Cr axis defining the CbCr color space by the angle θ (θ=5 degrees to 50 degrees).

Subsequently, in step S6, the image processing unit 220 judges whether or not the variable n indicating the pixel to be processed is smaller than the number of pixels N set in step S2.

When, as a result of the judgment in step S6, the variable n indicating the pixel to be processed is smaller than the number of pixels N set in step S2 (S6/YES), it is determined that the processing is performed on not all of the pixels of the original color image captured in step S1, and the processing proceeds to step S7.

When the processing proceeds to step S7, the image processing unit 220 adds 1 to the variable n indicating the pixel to be processed, to thereby change the pixel to be processed n. Further, the processing in and after step S4 is performed again on the changed pixel n.

On the other hand, when, as a result of the judgment in step S6, the variable n indicating the pixel to be processed is not smaller than the number of pixels N set in step S2 (S6/NO), it is determined that the processing is performed on all of the pixels of the original color image captured in step S1, and the processing proceeds to step S8.

When the processing proceeds to step S8, the image processing unit 220 performs drawing processing based on the pixel data after being subjected to the hue conversion processing in steps S4 and S5. Through the drawing processing, the hue-converted color image is generated.

Subsequently, in step S9, the display control unit 230 performs a control to display the hue-converted color image generated in step S8 on the display section 109. At this time, the display control unit 230 performs a control, in accordance with an instruction from the user and the like, to make the hue-converted color image generated in step S8 and the original color image captured in step S1 to be displayed side-by-side on the display section 109, or to make both of the images to be alternately displayed on the display section 109.

In the present embodiment, the original color image capturing unit 210 captures the original color image of moving image, so that when the processing in step S9 is completed, the processing returns to “START”, and the processing of step S1 to step S9 is conducted every time the next original color image is captured.

In the multi-function mobile phone (image processing device) 100 according to the embodiment of the present invention described above, it is set that the value of Cr component of each pixel data is first made to be zero to remove the most part of the red and green color components (but, a yellow-green color component is remained), and thereafter, in order to remove the yellow-green color component, the hue rotation processing of 5 degrees to 50 degrees (about 15 degrees to 25 degrees, as the optimum value) in the CbCr color space is conducted. Here, the reason why the hue rotation processing of 5 degrees to 50 degrees in the CbCr color space is conducted in the embodiment of the present invention is because, if the rotation angle becomes less than 5 degrees, it becomes difficult to remove the yellow-green color component, and further, if the rotation angle exceeds 50 degrees, noticeable red and green color components are newly appeared.

With the configuration as above, since the processing of making the value of Cr component of each pixel data to be zero, is first conducted, it is possible to perform the hue rotation processing based on the above-described expression (3) and expression (4), in which the processing load is reduced compared to that of the hue rotation processing based on the above-described expression (1) and expression (2).

Further, with the configuration as above, it is possible to generate the hue-converted color image as a result of removing, from the original color image, the color components of reddish to greenish colors, which are difficult to be distinguished by the Type-P/Type-D dichromat. Further, by displaying the hue-converted color image, the normal color vision person can grasp the visual perception of the Type-P/Type-D dichromat by, for example, comparing the displayed hue-converted color image and the object H with his/her eyes. Further, the normal color vision person can grasp the visual perception of the Type-P/Type-D dichromat also by making the hue-converted color image and the original color image before performing the hue conversion processing to be displayed side-by-side, or by making both of the images to be alternately displayed, for example.

Specifically, with the use of the multi-function mobile phone (image processing device) 100 according to the embodiment of the present invention, it is possible to provide the mechanism enabling the normal color vision person (trichromat) to grasp the visual perception of the Type-P/Type-D dichromat while suppressing the processing load of the image processing in the color image.

### Another Embodiment

In the above-described embodiment of the present invention, when conducting the hue rotation processing performed by the hue rotation processing unit 222, the processing is performed on each pixel data of the color image after being subjected to the processing performed by the Cr component elimination processing unit 221, by rotating and moving the Cb axis and the Cr axis defining the CbCr color space by 5 degrees to 50 degrees (about 15 to 25 degrees, as the optimum value) (refer to FIG. 4). However, the present invention is not limited to this mode, and the following mode can also be applied.

Specifically, the mode in which the hue rotation processing is performed by rotating and moving the value of Cb component and the value of Cr component in each pixel data of the color image after being subjected to the processing performed by the Cr component elimination processing unit 221 by 5 degrees to 50 degrees (about 15 degrees to 25 degrees, as the optimum value) on the basis of the CbCr color space, contrary to the processing in the above-described embodiment of the present invention, is also applicable to the present invention.

Further, in the above-described embodiment of the present invention, the coordinate system represented by YCbCr is employed as the color space in the color image of the object H, but, the present invention is not limited to this coordinate system. For example, a coordinate system represented by a luminance signal, a first chromatic (color difference) signal of mainly yellow and blue, and a second chromatic (color difference) signal of mainly red and green, is also applicable to the present invention. When this coordinate system is applied, the following mode is employed.

First, the original color image capturing unit 210 in FIG. 2 captures a color image represented by a luminance signal, a first color difference signal of mainly yellow and blue, and a second color difference signal of mainly red and green, as an original color image of the object H.

Subsequently, the image processing unit 220 in FIG. 2 performs processing to make a value of the second color difference signal to be zero, on each pixel data of the original color image captured by the original color image capturing unit 210. In this case, it is designed such that a second color difference signal elimination processing unit, instead of the Cr component elimination processing unit 221, is configured in the inside of the image processing unit 220 in FIG. 2, and the second color difference signal elimination processing unit performs the processing to make the value of the second color difference signal to be zero.

Next, the hue rotation processing unit 222 in the inside of the image processing unit 220 in FIG. 2 performs, on each pixel data of the color image after being subjected to the processing performed by the second color difference signal elimination processing unit, hue rotation processing for removing the remaining red or green color component in the color space defined by the first color difference signal and the second color difference signal, being a color component significantly perceived by the normal color vision person, which is particularly a color component of yellow-green and the like.

Subsequently, the display control unit 230 in FIG. 2 performs a control to display the color image after being subjected to the hue rotation processing performed by the hue rotation processing unit 222, on the display section 109 as a hue-converted color image. At this time, the display control unit 230 in FIG. 2 performs a control, in accordance with an instruction from the user and the like, to make the hue-converted color image and the original color image to be displayed side-by-side on the display section 109, or to make both of the images to be alternately displayed on the display section 109.

Through the above-described processing, it is possible to generate the hue-converted color image based on the concept similar to that of the above-described embodiment of the present invention, and it is possible to achieve operation and effect similar to those of the above-described embodiment of the present invention.

Further, the present invention can also be realized by executing the following processing.

Specifically, it is processing in which software (program product) to realize a function of the aforementioned embodiments is provided to a system or a device via a network or various types of storage media, and a computer (or CPU, MPU or the like) of that system or device reads out and executes the program product.

The program product and a computer-readable recording medium storing the program product are included in the present invention.

According to the present invention, it is possible to provide a mechanism enabling a normal color vision person to grasp a visual perception of a color deficient person (Type-P/Type-D dichromat) while suppressing a processing load of image processing in a color image.

It should be noted that the above embodiments of the present invention merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. An image processing device, comprising:
a color image capturing unit capturing a color image of a object represented by a luminance signal, a first color difference signal of mainly yellow and blue, and a second color difference signal of mainly red and green;
a second color difference signal elimination processing unit performing, on each pixel data of the color image, processing to make a value of the second color difference signal to be zero;
a hue rotation processing unit performing, on each pixel data of the color image after being subjected to the processing performed by said second color difference signal elimination processing unit, hue rotation processing to eliminate a remaining red or green color component in a color space defined by the first color difference signal and the second color difference signal; and
a display control unit performing a control to display the color image after being subjected to the hue rotation processing performed by said hue rotation processing unit, on a display section as a hue-converted color image.

2. An image processing device, comprising:
a color image capturing unit capturing a color image of a object represented by YCbCr;
a Cr component elimination processing unit performing, on each pixel data of the color image, processing to make a value of Cr component to be zero;
a hue rotation processing unit performing, on each pixel data of the color image after being subjected to the processing performed by said Cr component elimination processing unit, hue rotation processing of 5 degrees to 50 degrees in a CbCr color space; and
a display control unit performing a control to display the color image after being subjected to the hue rotation processing performed by said hue rotation processing unit, on a display section as a hue-converted color image.

3. The image processing device according to claim 2, wherein
said hue rotation processing unit performs the hue rotation processing on each pixel data of the color image after being subjected to the processing performed by said Cr component elimination processing unit, by rotating and moving a Cb axis and a Cr axis defining the CbCr color space by 5 degrees to 50 degrees.

4. The image processing device according to claim 2, wherein
said hue rotation processing unit performs the hue rotation processing by rotating and moving a value of Cb component and a value of Cr component in each pixel data of the color image after being subjected to the processing performed by said Cr component elimination processing unit, by 5 degrees to 50 degrees on the basis of the CbCr color space.

5. The image processing device according to claim 1, wherein
the color image captured by said color image capturing unit is a color image of moving image.

6. The image processing device according to claim 2, wherein
the color image captured by said color image capturing unit is a color image of moving image.

7. An image processing method, comprising:
a color image capturing step of capturing a color image of a object represented by a luminance signal, a first color difference signal of mainly yellow and blue, and a second color difference signal of mainly red and green;
a second color difference signal elimination processing step of performing, on each pixel data of the color image, processing to make a value of the second color difference signal to be zero;
a hue rotation processing step of performing, on each pixel data of the color image after being subjected to the processing performed by said second color difference signal elimination processing step, hue rotation processing to eliminate a remaining red or green color component in a color space defined by the first color difference signal and the second color difference signal; and
a display control step of performing a control to display the color image after being subjected to the hue rotation processing performed by said hue rotation processing step, on a display section as a hue-converted color image.

8. An image processing method, comprising:
a color image capturing step of capturing a color image of a object represented by YCbCr;
a Cr component elimination processing step of performing, on each pixel data of the color image, processing to make a value of Cr component to be zero;
a hue rotation processing step of performing, on each pixel data of the color image after being subjected to the processing performed by said Cr component elimination processing step, hue rotation processing of 5 degrees to 50 degrees in a CbCr color space; and
a display control step of performing a control to display the color image after being subjected to the hue rotation processing performed by said hue rotation processing step, on a display section as a hue-converted color image.

9. A program product for causing a computer to execute:
a color image capturing step of capturing a color image of a object represented by a luminance signal, a first color difference signal of mainly yellow and blue, and a second color difference signal of mainly red and green;
a second color difference signal elimination processing step of performing, on each pixel data of the color image, processing to make a value of the second color difference signal to be zero;
a hue rotation processing step of performing, on each pixel data of the color image after being subjected to the processing performed by said second color difference signal elimination processing step, hue rotation processing to eliminate a remaining red or green color component in a color space defined by the first color difference signal and the second color difference signal; and
a display control step of performing a control to display the color image after being subjected to the hue rotation processing performed by said hue rotation processing step, on a display section as a hue-converted color image.

10. A program product for causing a computer to execute:
a color image capturing step of capturing a color image of a object represented by YCbCr;
a Cr component elimination processing step of performing, on each pixel data of the color image, processing to make a value of Cr component to be zero;
a hue rotation processing step of performing, on each pixel data of the color image after being subjected to the processing performed by said Cr component elimination processing step, hue rotation processing of 5 degrees to 50 degrees in a CbCr color space; and
a display control step of performing a control to display the color image after being subjected to the hue rotation processing performed by said hue rotation processing step, on a display section as a hue-converted color image.
